(19) United States
(12) Patent Application Publication
(10) Pub. No.: US 2022/0409479 A1
(43) Pub. Date: Dec. 29, 2022

(54) CAMBERED MASSAGER FITTED TO OUTLINE OF HEAD

(71) Applicant: Shanghai Sintang Industrial Co.,Ltd., Shanghai (CN)

(72) Inventors: Chuankui Du, Shanghai (CN); Saihua Chen, Shanghai (CN); Jinnian Dong, Shanghai (CN)

(73) Assignee: Shanghai Sintang Industrial Co.,Ltd., Shanghai (CN)

(21) Appl. No.: 17/900,887

(22) Filed: Sep. 1, 2022

(30) Foreign Application Priority Data
Jun. 14, 2022 (CN) 202221495901.9

(51) Int. Cl. A61H 23/02

(52) U.S. Cl. CPC A61H 23/0218; A61H 2205/021

(57) ABSTRACT

The present disclosure is applicable to the technical field of massage apparatuses, and provides a cambered massager fitted to the outline of a head. The cambered massager includes a first elastic cambered carrier, a first protective wrap layer, a battery unit, a control unit and a button; the first elastic cambered carrier is fitted and assembled to first protective wrap layer to form an overall shell approximate to a cambered head clasp; first protective wrap layer carries several protruding point-like massage units; first massage vibration sources are mounted inside massage units; battery unit is connected to the control unit; the control unit is connected to the first massage vibration sources; the button is connected to control unit; and first massage vibration sources vibrate under control of control unit. The control unit can turn on and turn off first massage vibration sources to vibrate and control vibration strength.

### TECHNICAL FIELD

The present disclosure belongs to the technical field of massage apparatuses, and particularly relates to a cambered massager fitted to the outline of a head.

### BACKGROUND

Head massage can promote blood circulation in the head, improve the oxygen uptake ability of the brain, and help improve the functions of the cerebral cortex. Head massage has effects of improving the hair quality, preventing hair loss and promoting hair growth. Massage can effectively stimulate the acupuncture points on the head to refresh the mind and eliminate fatigue, and can also relieve tension, anxiety and other emotions, thus reenergizing the brain. Head massage can relax local tense fascia and achieve a purpose of alleviating a headache. There are many acupuncture points on the head, and many main and collateral channels pass through the head. Head massage has many benefits for dredging the channels.

Most of existing head massagers are designed into bulky hard plastic helmets, which have a large volume, cannot meet demands for heads with different sizes and outlines, and is not convenient to carry around. Such a helmet is not beautiful enough when it is worn.

### SUMMARY

An embodiment of the present disclosure aims to provide a cambered massager fitted to the outline of a head. The cambered massager fitted to the outline of a head has a head massage function and has a camber and elasticity approximate to a hair clasp. Therefore, the cambered massager can be more in line with the outline of a head and has a small volume, which aims at solving the problems that the existing head massager is inconvenient to carry around and that the head massager is not beautiful and fitting enough when it is worn.

The embodiment of the present disclosure is achieved below: A cambered massager fitted to the outline of a head includes:

a first elastic cambered carrier, a first protective wrap layer, a battery unit, a control unit and a button, wherein the first elastic cambered carrier is fitted and assembled to the first protective wrap layer to form an overall shell approximate to a cambered head clasp; the first protective wrap layer carries several protruding point-like massage units; first massage vibration sources are mounted inside the massage units; the battery unit is connected to the control unit; the control unit is connected to the first massage vibration sources; the button is connected to the control unit; and the first massage vibration sources vibrate under control of the control unit.

In a further technical solution, the overall shell has a camber and elasticity approximate to the hair clasp; the overall shell is applicable to different head circumferences and outlines through the camber and the elasticity; and the overall shell wraps up the outline of the head through the camber and the elasticity.

In a further technical solution, parts of the massage units that are in contact with the head are protruding points.

In a further technical solution, the massage units protrude from an inner surface of the first protective wrap layer.

In a further technical solution, the cambered massager includes a plurality of massage units which are distributed on a lower surface of the first protective wrap layer in a dispersed manner.

In a further technical solution, each massage unit has an elastic retractility, so that the massage unit is adjusted by self extension and retraction to be in full contact with the head.

In a further technical solution, the massage units are flexibly connected to the first protective wrap layer; and the massage units have an elastic retractility and a 360-degree flexible swinging ability due to the flexible connection between the massage units and the first protective wrap layer.

In a further technical solution, the first massage vibration sources convert simple vibration into swing and touch to massage the head of a user in a vibrating, stroking and finger-pressing manner through the elastic retractility and the 360-degree flexible swinging ability of the massage units.

In a further technical solution, a cavity structure for storing a connecting wire between the control unit and the first massage vibration sources and other electronic elements is formed inside the overall shell.

According to the cambered massager fitted to the outline of a head provided by the embodiment of the present disclosure, a user wears the first elastic cambered carrier on the head; the overall shell assembled by fitting the first elastic cambered carrier to the first protective wrap layer has the camber approximate to a hair clasp and is as elastic as the hair clasp, so that the overall shell can adapt to heads with different head circumferences and outlines and can wrap up the outlines of the heads; the parts of the massage units that are in contact with the head are protruding points; the massage units have a certain elastic retractability and can adapt to a partial concave-convex position of the surface of the head of the user; the first massage vibration sources are mounted in the massage units; and when the first massage vibration sources vibrate, partial vibration is converted into swing and touch through the massage units to massage the head of the user in a vibrating, stroking and finger-pressing manner. The present application has a simple structure and lightweight design, and is convenient to carry around.

### BRIEF DESCRIPTION OF THE DRAWINGS

FIG. 1 is a schematic structural diagram of a cambered massager fitted to the outline of a head provided by an embodiment of the present disclosure;

FIG. 2 is an exploded diagram of a cambered massager fitted to the outline of a head provided by an embodiment of the present disclosure;

FIG. 3 is a schematic diagram of a massage unit of a cambered massager fitted to the outline of a head provided by an embodiment of the present disclosure;

FIG. 4 is a schematic diagram of wearing of a cambered massager fitted to the outline of a head provided by an embodiment of the present disclosure.

In the drawings: first elastic cambered carrier 1, massage unit 2, first massage vibration source 3, first protective wrap layer 4, a battery unit 5, a control unit 6, and a button 7.

### DETAILED DESCRIPTION OF THE EMBODIMENTS

In order to make the objectives, technical solutions and advantages of the present disclosure clearer, the present disclosure is further described in detail below with reference to accompanying drawings and embodiments. It should be understood that the specific embodiments described here are merely to illustrate and explain the present disclosure, and not intended to limit the present disclosure.

Specific implementation of the present disclosure is described in detail below in combination with specific embodiments.

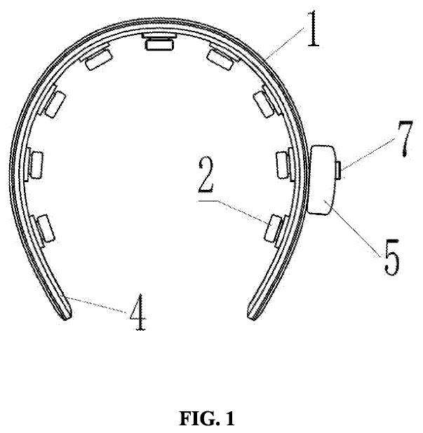

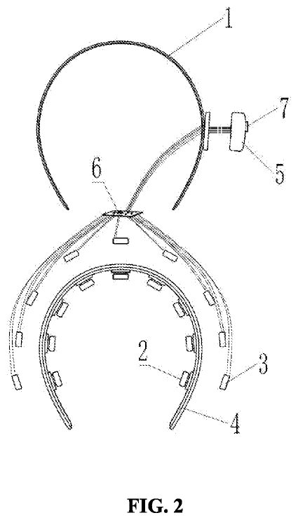

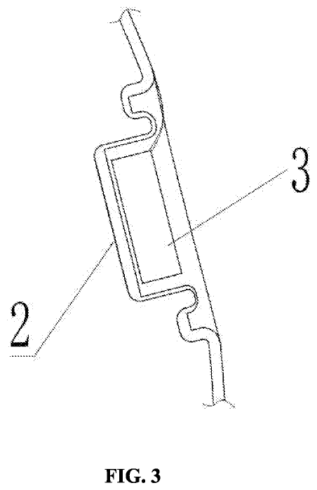

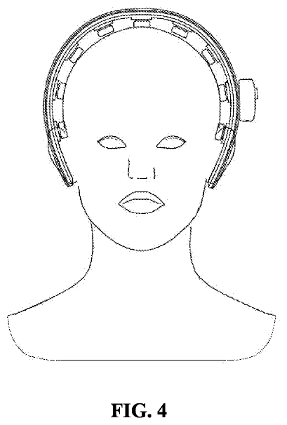

As shown in FIG. 1 to FIG. 4, a cambered massager fitted to the outline of a head provided in one embodiment of the present disclosure is illustrated, including:

a first elastic cambered carrier 1, a first protective wrap layer 4, a battery unit 5, a control unit 6 and a button 7. The first elastic cambered carrier 1 is fitted and assembled to the first protective wrap layer 4 to form an overall shell approximate to a cambered head clasp; the first protective wrap layer 4 carries several protruding point-like massage units 2; first massage vibration sources 3 are mounted inside the massage units 2; the battery unit 5 is connected to the control unit 6; the control unit 6 is connected to the first massage vibration sources 3; the button 7 is connected to the control unit 6; and the first massage vibration sources 3 vibrate under control of the control unit 6.

In the embodiment of the present disclosure, during use, the battery unit 5 supplies power to the first massage vibration sources 3 through the control unit 6; an instruction is sent to the control unit 6 through the button 7; and the control unit 6 supplies electric energy to the first massage vibration sources 3 according to a program setting, and controls turning on, turning off, strength and time of the vibration of the first massage vibration sources 3.

As shown in FIG. 1, as a preferable embodiment of the present disclosure, the overall shell has a camber and elasticity approximate to the hair clasp; the overall shell is applicable to different head circumferences and outlines through the camber and the elasticity; and the overall shell wraps up the outline of the head through the camber and the elasticity.

In the embodiment of the present disclosure, the first elastic cambered carrier 1 has a camber and elasticity approximate to a hair clasp since it is formed by injection molding of an elastic polycarbonate (PC) material. The overall camber of the embodiment of the present disclosure can be changed through elastic deformation. A user wears the embodiment of the present disclosure on the head just like wearing the hair clasp. The embodiment of the present disclosure can naturally wrap up the outline of the head.

As shown in FIG. 1, as a preferable embodiment of the present disclosure, parts of the massage units 2 that are in contact with the head are protruding points.

In the embodiment of the present disclosure, the first protective wrap layer 4 is formed by injection molding of soft silicone and carries a plurality of protruding point-like massage units 2. The massage units 2 protrude from the first protective wrap layer 4.

As shown in FIG. 1, as a preferable embodiment of the present disclosure, the massage units 2 protrude from an inner surface of the first protective wrap layer 4.

In the embodiment of the present disclosure, the massage units 2 protrude from the inner surface of the first protective wrap layer 4, so that the massage units 2 are in contact with the head preferentially.

As shown in FIG. 1, as a preferable embodiment of the present disclosure, the cambered massager includes a plurality of massage units which are distributed on the lower surface of the first protective wrap layer in a dispersed manner.

In the embodiment of the present disclosure, the massage effect is enhanced by means of disposing the plurality of massage units.

As shown in FIG. 1, as a preferable embodiment of the present disclosure, each massage unit has an elastic retractility, so that the massage unit is adjusted by self extension and retraction to be in full contact with the head.

In the embodiment of the present disclosure, the first elastic cambered carrier 1 is formed by injection molding of an elastic PC material, and the first protective wrap layer 4 is formed by injection molding of soft silicone, so that they have a camber and elasticity approximate to a hair clasp. The overall camber of the embodiment of the present disclosure can be changed through elastic deformation. A user wears the embodiment of the present disclosure on the head just like wearing the hair clasp. The embodiment of the present disclosure can naturally wrap up the outline of the head.

As shown in FIG. 1, as a preferable embodiment of the present disclosure, the massage units 2 are flexibly connected to the first protective wrap layer 4; and the massage units have an elastic retractility and a 360-degree flexible swinging ability due to the flexible connection between the massage units 2 and the first protective wrap layer 4.

In the embodiment of the present disclosure, when the first massage vibration sources 3 vibrate, the simple vibrations of part of the first massage vibration sources 3 are converted into swing and touch to massage the head of a user in a vibrating, stroking and finger-pressing manner through the elastic retractility and the 360-degree flexible swinging ability of the massage units 2.

As shown in FIG. 1, as a preferable embodiment of the present disclosure, the control unit 6 independently supplies electric energy to the plurality of first massage vibration sources 3 according to a program setting, and controls turning on, turning off, strength and time of the vibration of each first massage vibration source 3.

The above embodiment of the present disclosure provides a cambered massager fitted to the outline of the head, which has the camber and elasticity approximate to the hair clasp, so that the cambered massager can be worn on the head just like a hair clasp. This massager can be used at home, at work and during a travel. The cambered massager has a small volume and light weight, is highly fitted to the outline of the head, has a simple structure, and is easy to store and convenient to carry around.

The above descriptions are only preferred embodiments of the present disclosure, and are not intended to limit the present disclosure. Some simple deductions or substitutions can also be made without departing from the concept of the present disclosure, such as adding infrared physiotherapy, Bluetooth, music voice and hot compress functions. Any modifications, equivalent substitutions and improvements made within the spirit and principle of the present disclosure shall all fall within the protection scope of the present disclosure.

What is claimed is:

1. A cambered massager fitted to the outline of a head, comprising:
a first elastic cambered carrier, a first protective wrap layer, a battery unit, a control unit and a button, wherein the first elastic cambered carrier is fitted and assembled to the first protective wrap layer to form an overall shell approximate to a cambered head clasp; the first protective wrap layer carries several protruding point-like massage units; first massage vibration sources are mounted inside the massage units; the battery unit is connected to the control unit; the control unit is connected to the first massage vibration sources; the button is connected to the control unit; and the first massage vibration sources vibrate under control of the control unit.

2. The cambered massager fitted to the outline of the head according to claim 1, wherein the overall shell has a camber and elasticity approximate to the hair clasp; the overall shell is applicable to different head circumferences and outlines through the camber and the elasticity; and the overall shell wraps up the outline of the head through the camber and the elasticity.

3. The cambered massager fitted to the outline of the head according to claim 1, wherein parts of the massage units that are in contact with the head are protruding points.

4. The cambered massager fitted to the outline of the head according to claim 1, wherein the massage units protrude from an inner surface of the first protective wrap layer.

5. The cambered massager fitted to the outline of the head according to claim 1, wherein the cambered massager comprises a plurality of massage units which are distributed on a lower surface of the first protective wrap layer in a dispersed manner.

6. The cambered massager fitted to the outline of the head according to claim 5, wherein each massage unit has an elastic retractility, so that the massage unit is adjusted by self extension and retraction to be in full contact with the head.

7. The cambered massager fitted to the outline of the head according to claim 1, wherein the massage units are flexibly connected to the first protective wrap layer; and the massage units have an elastic retractility and a 360-degree flexible swinging ability due to the flexible connection between the massage units and the first protective wrap layer.

8. The cambered massager fitted to the outline of the head according to claim 5, wherein the first massage vibration sources convert simple vibration into swing and touch to massage the head of a user in a vibrating, stroking and finger-pressing manner through the elastic retractility and the 360-degree flexible swinging ability of the massage units.

9. The cambered massager fitted to the outline of the head according to claim 1, wherein a cavity structure for storing a connecting wire between the control unit and the first massage vibration sources and other electronic elements is formed inside the overall shell.
